(19) United States
(12) Patent Application Publication
(10) Pub. No.: US 2005/0203861 A1
(43) Pub. Date: Sep. 15, 2005

(54) Data handling

(76) Inventors: Lindsay Neale Somerville, Queensland (AU); Pramod Sharma, Queensland (AU); Dean Carson, New South Wales (AU); Mark Allen, Queensland (AU); Terry De Lacy, Queensland (AU); Peter O'Clery, Australian Capital Territory (AU)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/508,295

(22) PCT Filed: Mar. 19, 2003
(86) PCT No.: PCT/AU03/00323

§ 371 Date: Apr. 28, 2005

(30) Foreign Application Priority Data
Mar. 20, 2002 (AU) PS 1199

(51) Int. Cl. G06F 7/00

(52) U.S. Cl. 707/1

(57) ABSTRACT

The present invention provides a method of processing data having one of two types. In particular, the first type of data is formed from a respective data instance, whereas the second type is formed from a number of data elements. In particular, if the data is the first data type, the method includes defining one or more associations between the data instance and any one of a predetermined model, keywords and, other data instances, storing the data instance in a store and storing knowledge data representing the defined associations in the store. In contrast if the data is the second data type, the method includes defining a data instance, the data instance being formed from one or more of the data elements. The method outlined above for the first type of data is then performed for the defined data instance.

### BACKGROUND OF THE INVENTION

The present invention relates to a method of processing data, and in particular to a method of processing data of different types to allow the data to be subsequent retrieved.

### DESCRIPTION OF THE PRIOR ART

The reference to any prior art in this specification is not, and should not be taken as, an acknowledgment or any form of suggestion that the prior art forms part of the common general knowledge in Australia.

In a modern business environment, businesses need ready access to the most relevant, the latest and most reliable information for business planning, marketing, development, and management.

Whilst many sources of information exist, there are typically no single sources of data that can provide all the information a business requires. Instead businesses typically have to obtain data from different sources. This in turn leads to additional problems, primarily as the data from different sources will be in different formats, and may be of different standards. This makes research and processing the data time consuming and as a result, it can be difficult for businesses to obtain the required information.

For example, Travel & Tourism has become one of Australia's largest and most rapidly expanding industries. Travel & Tourism is diverse in terms of spread of sectors; transport, hospitality, retail, accommodation, touring, entertainment—geography; right across urban, regional and rural Australia—and size; micro family businesses to large global corporations. It is intensely competitive with few barriers to trade or entry into the industry.

Accordingly, to retain a competitive advantage businesses need ready access to the most relevant, the latest and most reliable information for business planning, marketing, development, and management. Whilst there are many private research and consulting companies supplying information, in particular to large enterprises, there is a considerable gap in the provision of quality business information.

Accordingly, there is a requirement for a system that is capable of handling data from different sources to allow businesses to obtain required information for generating reports from a single source.

### SUMMARY OF THE PRESENT INVENTION

In a first broad form the present invention provides a method of processing data, the data being of a first type in which the data is formed from a respective data instance, or a second type in which the data is formed from a number of data elements, the method including:
a) Receiving the data;
b) Determining the data type; and,
c) If the data is the first data type, the method further includes:
   i) Defining one or more associations between the data instance and any one of:
      (1) A predetermined model;
      (2) Keywords; and,
      (3) Other data instances;
   ii) Storing the data instance in a store;
   iii) Storing knowledge data representing the defined associations in the store;
d) If the data is the second data type:
   i) Defining a data instance, the data instance being formed from one or more of the data elements;
   ii) Defining one or more associations between the data instance and any one of:
      (1) A predetermined model;
      (2) Keywords; and,
      (3) Other data instances;
   iii) Storing the data instance in a store; and,
   iv) Storing knowledge data representing the defined associations in the store.

If the data is the second data type, the method of defining the one or more associations typically further includes:
a) Receiving one or more associations with the data; and,
b) Applying the one or more associations to each defined data instance.

The method of defining the one or more associations usually includes:
a) Determining content represented by the data;
b) Determining the semantics of the content; and,
c) Performing at least one of:
   i) Comparing the semantics to the predetermined model to create an association therebetween; and,
   ii) Using the semantics to select one or more keywords; and,
d) Comparing the semantics to the semantics of other data instances to create an association therebetween.

The model usually includes at least a number of entities, each entity relating to a respective portion of the tourism industry. In this case, the method of comparing the semantics to the predetermined model to create an association therebetween generally includes:
a) Comparing the semantics of the content to each entity; and,
b) Creating an association between the entity and the data instance in response to a successful comparison.

The model usually further including a number of sub entities, each sub entity relating to a respective portion of a respective entity, in which case the method of comparing the semantics to the predetermined model to create an association therebetween typically further includes:
a) Comparing the semantics of the content to each sub entity; and,
b) Creating an association between the sub entity and the data instance in response to a successful comparison.

The method preferably includes using a processing system, the processing system including an input for receiving commands from a user, the processing system being adapted to:
a) Receive the data;
b) Determine the data type;
c) Display an indication of the content and the data type to the user;
d) Receive input commands defining any associations;
e) Generate the knowledge data; and,
f) Store the knowledge data and the data instance in a store.

The store is typically a database.

If the data is the second data type, the method of storing the data generally includes:
a) Generating a respective data table in the database;
b) Propagating the table with the content of the data instance, each data element being placed in a respective column of the table.

The first type of data is typically a self-contained document, in any one of a number of formats.

The second type of data is typically statistical data.

The method usually further includes:
a) Determining the manner in which the data instance is to be displayed; and,
b) Including an indication of the manner in the knowledge data.

In a second broad form the present invention provides a system for processing data, the data being of a first type in which the data is formed from a respective data instance, or a second type in which the data is formed from a number of data elements, the system including:
a) A store; and,
b) A processor adapted to:
   i) Receive the data;
   ii) Determine the data type; and,
   iii) If the data is the first data type:
      (1) Define one or more associations between the data instance and any one of:
         (a) A predetermined model;
         (b) Keywords; and,
         (c) Other data instances;
      (2) Store the data instance in a store;
      (3) Store knowledge data representing the defined associations in the store;
   iv) If the data is the second data type:
      (1) Define a data instance, the data instance being formed from one or more of the data elements;
      (2) Define one or more associations between the data instance and any one of:
         (a) A predetermined model;
         (b) Keywords; and,
         (c) Other data instances;
      (3) Store the data instance in a store; and,
      (4) Store knowledge data representing the defined associations in the store.

The system is preferably to perform the method of the first broad form of the invention.

In a third broad form the present invention provides a computer program product for processing data, the data being of a first type in which the data is formed from a respective data instance, or a second type in which the data is formed from a number of data elements, the computer program product including computer executable code which when executed on a suitable processing system causes the processing system to perform the method of the first broad form of the invention.

In a fourth broad form the present invention provides a method of retrieving data stored in a store, the data being stored as respective data instances, with each data instance being associated with a predetermined model, the model including at least a number of entities, the method including:
a) Selecting one or more of the entities;
b) Viewing an indication of each data instance associated with each selected entity;
c) Selecting one of the data instances; and,
d) Retrieving the data instance from the store.

The method is preferably performed using a processing system coupled to the store, the processing system being adapted to:
a) Cause the model to be displayed to a user;
b) Determine an entity selection in accordance with input commands received from the user;
c) Determine each data instance associated with each selected entity;
d) Cause an indication of each data instance to be displayed to the user;
e) Determine a data instance selection in accordance with input commands received from the user; and,
f) Retrieve the data instance from the store.

The store usually further stores knowledge data representing the any defined associations, the method of determining each data instance associated with each selected entity including causing the processing system to:
a) Access the knowledge data stored in the store; and,
b) Determine each data instance in accordance with the entity selection and the knowledge data.

The data may be of a first type in which the data is formed from a respective data instance formed from a self contained document having any one of a number of formats, or a second type in which the data is formed from a number of data elements. In this case, the method of retrieving the data from the store usually includes causing the processing system to:
a) Determine the type of the data instance;
b) If the data is the first data type, display the content of the document to the user; and,
c) If the data is the second data type:
   i) Obtain the data elements; and,
   ii) Use the data elements to generate a report; and,
   iii) Display the report to the user.

The processing system can be formed from first and second processing systems coupled via a communications system, in which case the method typically includes:
a) Using the first processing system to:
   i) Receive input commands from the user, and transfer an indication of the received commands to the second processing system; and,
   ii) Display information from the second processing system to the user, including at least one of:
      (1) The model;
      (2) Indications of data instances; and,
      (3) Data instances; and,
b) Using the second processing system to:
   i) Determine the entity selection in accordance with the indication of the input commands received from the first processing system;
   ii) Determine each data instance associated with each selected entity;
   iii) Transfer the indication of each data instance to the first processing system;
   iv) Determine the data instance selection in accordance with the indication of the input commands received from the first processing system;
   v) Retrieve the data instance from the store; and,
   vi) Transfer the data instance to the first processing system for display to the user.

Each entity may relate to a respective portion of the tourism industry, the data instances providing information relating to the tourist industry.

In a fifth broad form the present invention provides a system for retrieving data stored in a store, the data being stored as respective data instances, with each data instance being associated with a predetermined model, the model including at least a number of entities, the system including:
a) A display;
b) A processor adapted to:
   i) Cause the model to be displayed to a user;
   ii) Determine an entity selection in accordance with input commands received from the user;
   iii) Determine each data instance associated with each selected entity;
   iv) Cause an indication of each data instance to be displayed to the user;
   v) Determine a data instance selection in accordance with input commands received from the user; and,
   vi) Retrieve the data instance from the store.

The system typically includes first and second processing systems coupled via a communications system, in which case the first processing system preferably includes the display and a first processor adapted to:
a) Receive input commands from the user, and transfer an indication of the received commands to the second processing system; and,
b) Display information received from the second processing system on the display, including at least one of:
   i) The model;
   ii) Indications of data instances; and,
   iii) Data instances.

The second processing system typically includes a processor coupled to the store, the processor being adapted to:
a) Determine the entity selection in accordance with the indication of the input commands received from the first processing system;
b) Determine each data instance associated with each selected entity;
c) Transfer the indication of each data instance to the first processing system;
d) Determine the data instance selection in accordance with the indication of the input commands received from the first processing system;
e) Retrieve the data instance from the store; and,
f) Transfer the data instance to the first processing system for display to the user.

Preferably the system is adapted to perform the method of the fourth broad form of the invention.

In a sixth broad form the present invention provides a computer program product for retrieving data stored in a store, the data being stored as respective data instances, with each data instance being associated with a predetermined model, the computer program including computer executable code which when executed on a suitable processing system causes the processing system to perform the method of the fourth broad form of the invention.

In a seventh broad form the present invention provides a model for use in data handling the model including:
a) A number of entities, each entity relating to a respective portion of the tourism industry;
b) A number of sub entities, each sub entity being associated with a respective one of the entities; and,
c) A number of associations, each association defining a relationship between a data instance and respective one of the entities and sub-entities, the data instances representing content relating to the tourist industry.

The model is typically being used in the method of the first and fourth broad forms of the invention.

### BRIEF DESCRIPTION OF THE DRAWINGS

An example of the present invention will now be described with reference to the accompanying drawings, in which:

FIG. 1 is a schematic diagram of an example of a system for implementing the present invention;

FIG. 2 is a schematic diagram of an example of one of the processing system of FIG. 1;

FIG. 3 is a schematic diagram of an example of one of the end stations of FIG. 1;

FIG. 4 is an example of a data model for use in the travel and tourism and industry;

FIGS. 5A and 5B are a flow-chart of an example of the manner in which data is added to the system of FIG. 1;

FIG. 6 is an example of a data packet screen used for adding non-cubed data to the system of FIG. 1;

FIG. 7 is an example of a data packet screen used for adding cubed data to the system of FIG. 1;

FIG. 8 is an example of a hierarchical classification screen displayed by the system of FIG. 1;

FIG. 9 is an example of the manner in which the Solution Frameworks may be defined within the system of FIG. 1;

FIG. 10 is an example of the structure of the data in the system of FIG. 1;

FIGS. 11A and 11B are a flow-chart of an example of the manner in which data packets can be located using the data model or keyword searching; and,

FIG. 12 is a flow-chart of an example of the manner in which data packets can be located using the Solution Frameworks.

### DETAILED DESCRIPTION OF THE PREFERRED EMBODIMENTS

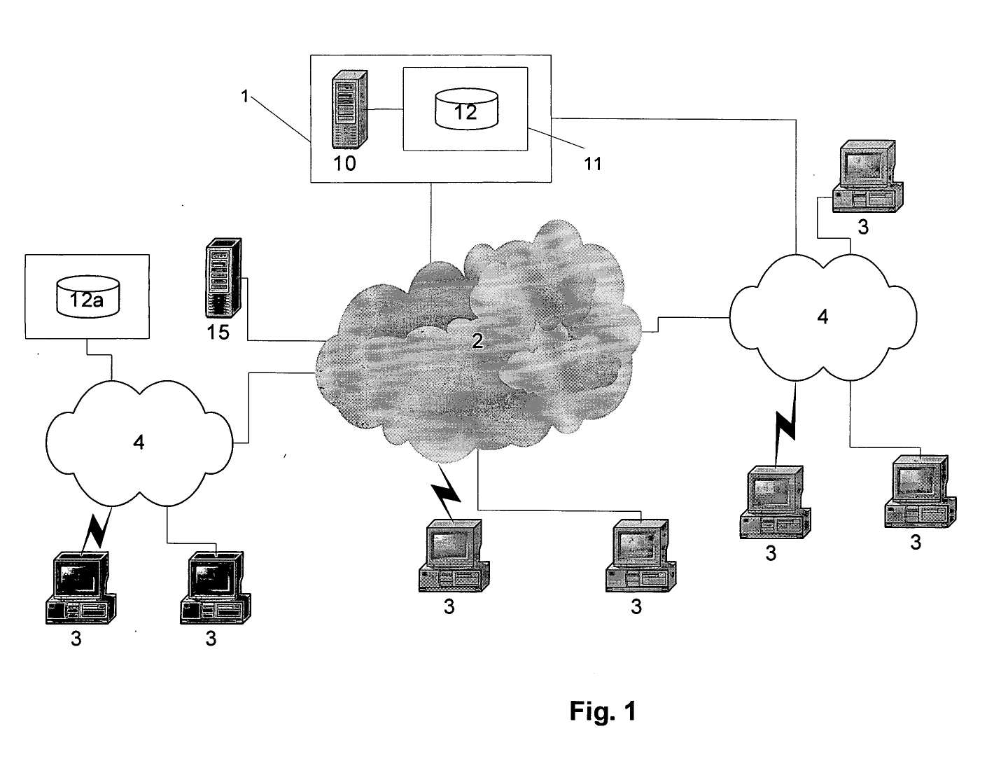

An example of the present invention will now be described with reference to FIG. 1, which shows a system suitable for implementing the present invention.

As shown, the system includes a base station 1 coupled to a number of end stations 3, via a communications network 2, and/or via a number of local area networks (LANs) 4. The base station 1 is generally formed from one or more processing systems 10 coupled to a data store 11, the data store 11 usually including a database 12, as shown.

In use, the base station 1 operates to process data received from the end stations 3, allowing the data to be subsequently searched and retrieved by users of other ones of the end stations 3.

It will therefore be appreciated that the system may be implemented using a number of different architectures. However, in this example, the communications network 2 is the Internet 2, with the LANs 4 representing private LANs, such internal LANs within a company or the like.

In this case, the services provided by the base station 1 are generally made accessible via the Internet 2, and accordingly, the processing systems 10 may be capable of generating web-pages or like that can be viewed by the users of the end stations 3.

Additionally data can be transferred between the end station 3 and the base station 1 using other techniques as represented by the dotted line. These other techniques may include for example transferring the data electronically on a physical medium, such as a floppy disk, CD-ROM, or the like, as will be explained in more detail below.

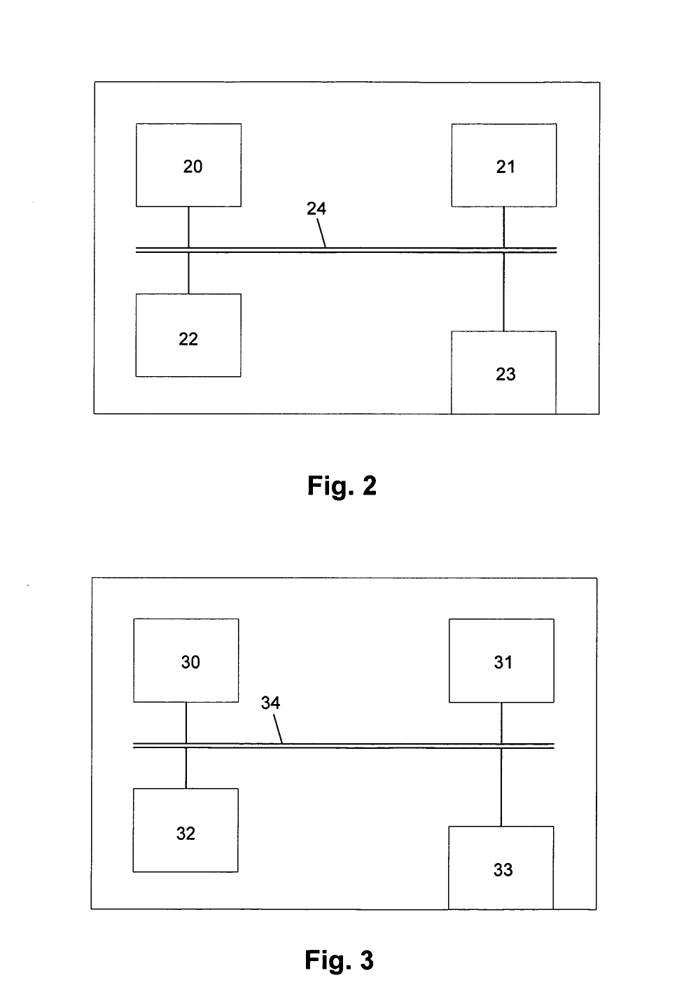

In any event, the processing systems 10 may be any form of processing system but typically includes a processor 20, a memory 21, an input/output (I/O) device 22 and an interface 23 coupled together via a bus 24, as shown in FIG. 2. The interface 23, which may be a network interface card, or the like, is used to couple the processing system to the Internet 2.

It will therefore be appreciated that the processing system 10 may be formed from any suitable processing system, which is capable of operating applications software to enable the data to be processed, stored and subsequently retrieved. However, in general the processing system 10 will be formed from a server, such as a network server, web-server, or the like.

Similarly, the end stations 3 must generally be capable of co-operating with the base station 1 to allow browsing of web-pages, or the transfer of data in other manners. Accordingly, in this example, as shown in FIG. 3, the end station 3 is formed from a processing system including a processor 30, a memory 31, an input/output (I/O) device 32 and an interface 33 coupled together via a bus 34. The interface 33, which may be a network interface card, or the like, is used to couple the end station 3 to the Internet 2.

It will be therefore be appreciated that the end station 3 may be formed from any suitable processing system, such as a suitably programmed PC, Internet terminal, lap-top, hand-held PC, or the like, which is typically operating applications software to enable web-browsing or the like.

Alternatively, the end station 3 may be formed from specialised hardware, such as an electronic touch sensitive screen coupled to a suitable processor and memory. In addition to this, the end station 3 may be adapted to connect to the Internet 2, or the LANs 4 via wired or wireless connections. It is also feasible to provide a direct connection between the base stations 1 and the end stations 3, for example if the system is implemented as a peer-2-peer network.

An overview of this operation of the system will now be described.

Overview

In use, the base station 1 operates to receive data from selected ones of the end stations 3 in one of two types, hereinafter referred to as cubed and non-cubed data.

In general, the cubed data is statistical data formed from a number of data elements. Each data element is a basic unit of information, typically relating to a specified statistic. Accordingly, each data element will represent a respective type of information from a statistical report. Thus, for example, data elements may correspond to the age, sex, nationality, or the like, of people questioned in a survey.

In contrast to this, non-cubed data is formed from packets that represent self-contained documents, such as information that has been pre-collated into spreadsheets, charts, maps, reports, or the like. Typically, non-cubed data is provided in a respective file type, such as a Word™ document, PDF document, or the like.

In use, an operative of the base station 1 operates to examine the content of the received data to determine the semantics of the content. The user then creates association between the data and a data model. The data model, which is discussed in more detail below, represents a high level of conceptualisation of the industry to which the data relates. Thus, it will be appreciated that a different model will be used by different industries.

The model is intended to represent the industry in its entirety, allowing the industry to be divided into distinct portions known as entities. The entities are further divided into sub-entities. By associating the data with a respective one of the entities or sub entities, this allows the data to be searched and subsequently retrieved.

The operative will also define keywords that allow the data to be searched by users of the end station 3 using keyword-searching techniques.

In addition to this, once the data has been associated with the model and stored in the database 12, the data can also be associated with one or more “Solution Frameworks”. The Solution Frameworks represent collections of data that together form a set of related information that would typically be used by members of the industry. Thus for example, each Solution Framework can correspond to a report that addresses questions typically raised by industry members.

Accordingly, this allows users of the end station 3 to retrieve data from the database 12 using the data model, the keywords, or the Solution Frameworks.

Data Model

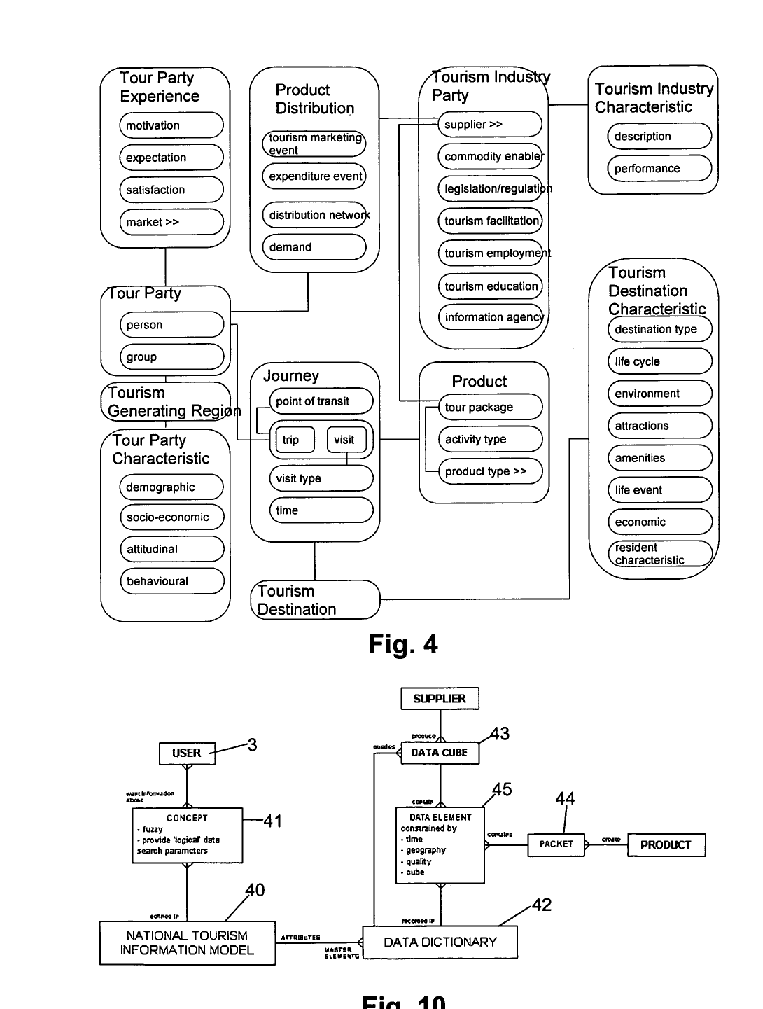

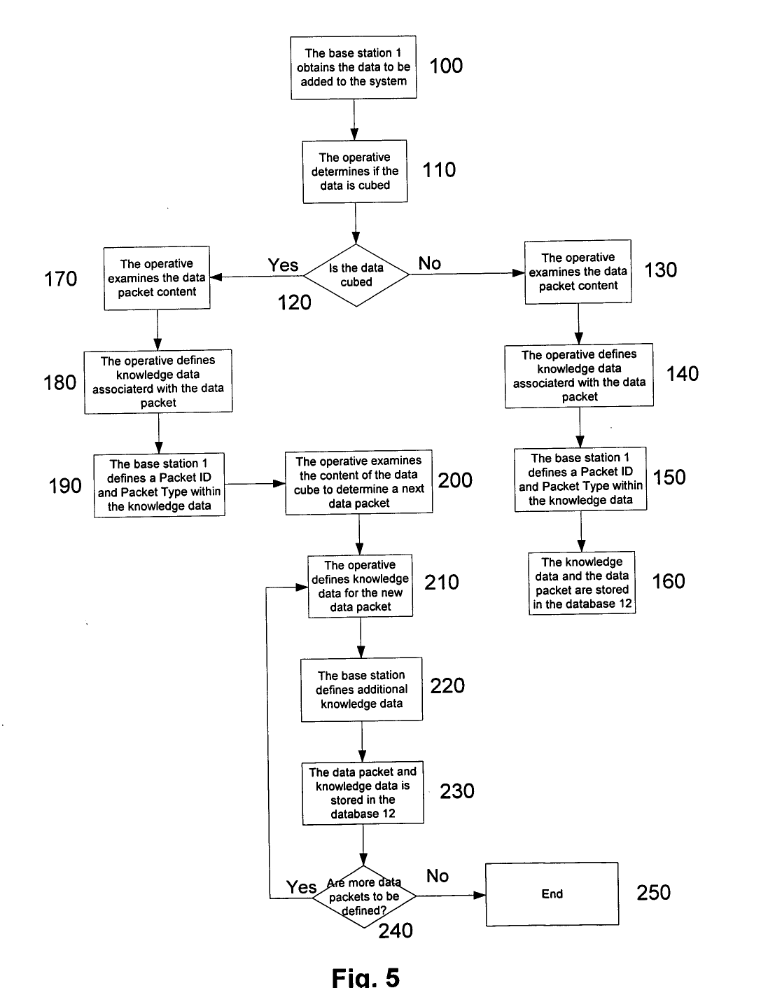

An example of a data model for use in the travel and tourism and industry is shown in FIG. 4. As shown, the model is formed from nine main entities details of which are set out in table 1 below.

The data model is determined by considering the operation of the industry and then dividing this into a number of respective proportions corresponding to the entities set out in table 1. Each of these entities is then further divided into a number of sub-entities which themselves may be divided into further sub-entities. Details of the first level of sub-entities are shown in FIG. 4.

TABLE 1

| Entity Type | Definition |
|---|---|
| Tour party | This information includes the persons or groups undertaking |
| | the tourism journey. |
| Tour Party | This information relates to the perceptions of the experience |
| Experience | of a tourism journey. Information might include: motivation to |
| | undertake a specific journey; or post-visit perceptions of the |
| | experience (satisfaction and so on). |
| Tour Party | This information describes the tour party rather than the |
| Characteristic | tourism experience. For example, perceptions of a specific |
| | tourism experience would be classified under the ‘tour party |
| | experience’ entity type, while general attitudinal |
| | characteristics (such as overall perceptions of tourism) are |
| | included within tour party characteristic. |
| Journey | This information relates to the time and location factors |
| | involved in a specific tourism event (normally called a trip or visit). |
| Tourism Destination | This information describes the location in which tourism |
| | activities take place. It may describe a specific location (such |
| | as a town), or a classification of locations (such as tourism |
| | regions). Tourism destination information may refer to any |
| | location within a journey; including the location of a stopover. |
| Tourism Destination | This information describes the environment of the locations in |
| Characteristic | which tourism occurs. This may include information relating to: |
| | the natural environment; the built environment; the economic |
| | environment; and the social environment. |
| Tourism Industry | This is information relating to all organisations involved in the |
| | supply of tourism products and activities. It may also cover |
| | organisations involved in facilitation and regulation of tourism. |
| | Information may relate to the individuals who work within |
| | tourism organisations, and the nature of their employment. |
| Product | Includes information relating to the goods and services |
| | consumed by the tour party or produced by the tourism |
| | industry. May also include activities engaged in by the tour |
| | party and facilitated by the tourism industry. |
| Product Distribution | This includes information about product promotion, and the |
| | act of purchasing tourism products. |

In use, the model is linked to a data dictionary. The data dictionary contains a list of keywords and associated synonyms, antonyms or the like. Each of the entities and sub-entities has attributes, which are effectively different fields of information within the entity. Thus, for example, if the entity relates to “Tour Party Characteristics” the attributes could be age, sex, country of origin etc. In any event, the entities and attributes are associated with respective ones of the keywords so that different keywords, or combinations of keywords will in turn be associated with selected ones of the entities or sub-entities. This allows the searching to be performed as will be described in more detail below.

Data Storage and Solution Framework Definition

A detailed example of the operation of the base station 1 with respect to the travel and tourism industry will now be defined.

FIG. 5 is a flow-chart outlining the manner in which data is added to the system and associated with respective keywords and the data model, to allow the data to be subsequently searched and retrieved.

As shown at step 100, the base station 1 operates to obtain the data to be added to the database 12. In the Travel & Tourism industry, data can be obtained from a number of suppliers in the public and private sectors. Suppliers can be classified as
Government
Government Agencies
Industry Organisations
Businesses
Consultancy Firms
Research Organisations
Small Area Specialists

The most significant suppliers currently are Government agencies, especially the Australian Bureau of Statistics and the Bureau of Tourism Research. However, there are many public and private sector resources that are not widely known or used by the travel & tourism industry.

The data can be obtained in many formats, typically depending on the supplier. Typical examples of the data formats, including
Statistical collections (unit record files URFs)
Numerical tables (summaries of URFs etc.)
Charts, maps, and other manipulable images (ie. Change appearance on manipulation of underlying data, or can be added to)
Static images
Unpublished reports/papers (ie. With flexible formatting)
Published reports/papers (inflexible formatting)
Newsletter/brochure/interpretation type (bites)
Multimedia formats

In most cases, data distribution is primarily managed by the supplier, with the data preferably being provided in electronic form from the end stations 3, for example in the form of e-mail, using an FTP (File Transfer Protocol), or the like.

However, there are some organisations that are responsible for distributing information from a variety of sources, such as government bookshops, libraries, and consultancy services, or the like, which do not currently distribute information in electronic form. Accordingly, in this instance it s necessary to receive the data in other forms, such as a hard format, with the data then being entered into the system manually by an operative of the base station 1.

In any event, at step 110 the operative examines the data to determine if the data is cubed. This may be achieved in a number of manners depending on the data itself. Thus, for example, the data may include an indication that the data is cubed or non-cubed data. Alternatively, the operative can simply examine the content of the data, or an accompanying description of the data to determine the data type. This will typically depend on the supplier of the data.

If it is determined that the data is non-cubed at step 120, the process moves on to step 130 where the operative examines the content of the data packet. Having determined the data packet content, the operative defines knowledge data representative of the data packet content.

The knowledge data sets out various information regarding the data packet, which allows the data packet to be retrieved from the database 12. In general the knowledge data includes at least an indication of:
Associations between the data packet and the model;
Keywords;
Relationships to other data packets;
A packet name and description.

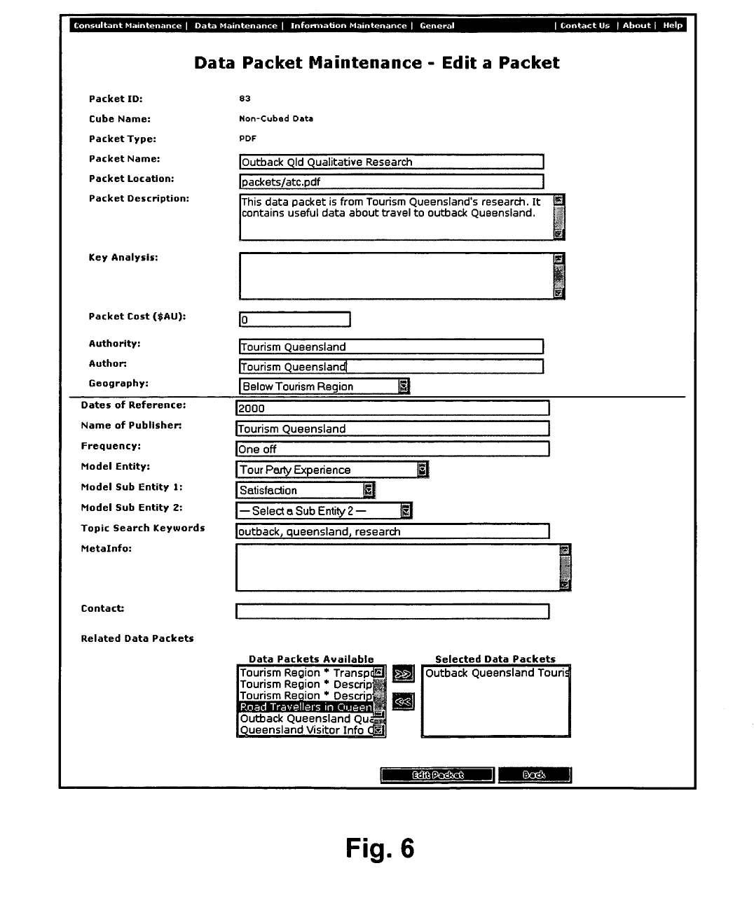

In order to define the knowledge data, the operative is presented with a data packet screen generated by the base station 1. The data packet screen includes a number of respective fields that must be completed by the user, together with a number of optional fields. An example of a data packet screen for non-cubed data is shown in FIG. 6.

Accordingly, in this example, the operative examines the data packet content and determines to which entity in the model the data packet is most closely related. An indication of this is then provided in the “Model Entity” field. Similarly associations can be defined with one or more sub-entities in the “Model Sub-Entity 1” and “Model Sub-Entity 2” fields as appropriate.

After this, the operative defines one or more keywords that usefully describe the data packet content. These are entered into the “Topic Search Keywords” field. A data packet name and description are also defined in the “Packet Name” and “Packet Description” fields respectively.

The operative can select one or more related data packets that include similar content to the current data packet. Thus, for example, a data packet containing an annual report may be linked to data packets containing annual reports from previous years. In order to define the relationships, the user is typically presented with a list of currently available data packets in the “Data Packets Available” field, which displays the Packet Name and Packet Description for each data packet. This allows the user to select those data packets that are to be related to the current data packet.

The operative may also define additional information, such as details of the data packet supplier, details of any costs associated with viewing the data packet, or the like, as will be evident from the remaining fields shown in FIG. 6.

Simultaneously with this, as shown at step 150, the base station will operate to define a “Packet ID” that is used when subsequently retrieving the data packets, as well as the data packet type, which represents the type of content contained in the data packet.

At step 160, the data packet and the associated knowledge data are stored in the database 12. Alternatively, in some circumstances, the data packet may not be stored in the database 12, and may instead remain at an external location that would be defined in the “Packet Location” field of the knowledge data.

In the event that the data is cubed data, then the process moves onto step 170, at which point the operative examines the content of the cubed data. At step 180, the operative defines knowledge data for the data cube. Again the knowledge data is typically defined by having the base station 1 present the user with an appropriate screen similar to that described above in FIG. 6.

In any event, the operative will generally define at least:
Associations between the data cube and the model;
Keywords;
A cube name and description.

At step 190 the base station will also operate to define a data cube ID, before the knowledge data is stored in the database 12 at step 200.

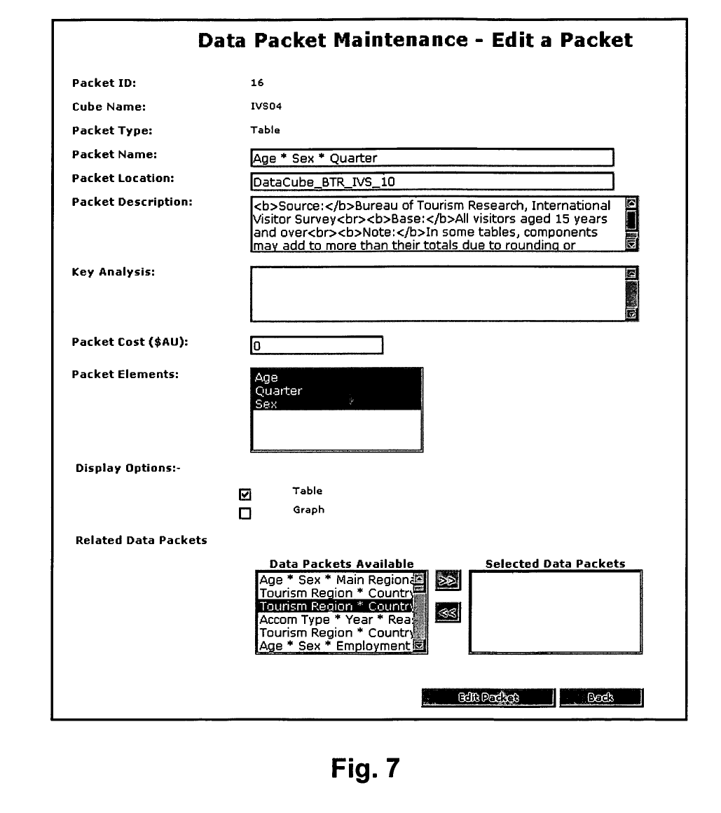

At step 210, the operative examines the content of the data cube to determine a next data packet, and define associated knowledge data at step 220. This is achieved by having the base station 1 present the user with a data packet definition screen, similar to that described above with respect to the non-cubed data. An example of the screen for cubed data is shown in FIG. 7.

In contrast to the non-cubed data case, the cubed data packet does not require that associations to the data model or keywords be defined. This is because this information is inherited from the knowledge data of the data cube.

Instead the user must select data elements from the data cube which should be included in the data packet. The data elements to be included in a single data packet are typically data elements which, when considered together, provide useful information. Thus, for example, the data packet will typically define a group of related statistics contained within the data cube. The operative selects the elements in the “Packet Elements” field.

The operative will also define other knowledge data for the data packet, including at least the “Packet Name”, “Packet Description” and “Packet Location”.

At step 230 the base station also defines additional knowledge data, including:
“Packet ID”—used to identify the respective data packet
“Cube Name”—indicating the data cube from which the packet was formed
“Packet Type”—indicating the data type contained in the data packet.

The base station 1 simultaneously combines the knowledge data provided by the operative with knowledge data inherited from the parent data cube. This knowledge data will include details of the associations with one or more entities, sub-entities or the like. This allows the base station 1 to automatically create associations between the data elements and respective entities, sub-entities and keywords, which in turn allows the data packet to be subsequently retrieved during searching.

In any event, once the knowledge data has been defined, the base station 1 operates to save the data packet and the associated knowledge data in the database 12, at step 240.

When the non-cubed data is saved in the database 12 at step 160 above, the data packet is simply saved as a respective file within the database. Thus the data packet is saved in its native format.

In contrast to this, when a data packet based on cubed data is to be stored, the data packet is stored as a respective table within the database, with the table being identified using the Packet ID. When stored in this fashion, each element of the data packet forms a respective column in the table, with each instance of a respective element being stored in a respective row. Thus it will be understood that the elements in the data packet generally correspond to entity attributes in the data model.

Thus for example, the data packet may relate to statistics provided by individuals regarding a tour or the like. In this example, the data packet would typically include data elements relating to information such as the individual's age, sex, nationality, name, or the like. In this case, each element would be assigned to a respective column, with the statistics relating to each individual being stored in a respective row. An example is shown in Table 2 below:

TABLE 2

| Age | Sex | Nationality | Name |
|---|---|---|---|
| 23 | M | British | Brian |
| 27 | M | Australian | Bruce |
| 25 | F | America | Dawn |

This allows each element in the cubed data to be readily mapped to respective entity attributes.

At step 250, the operative determines whether any more packets are to be defined. If so, the process returns to step 210 to allow subsequent packets to be defined. Otherwise, the process ends at step 260.

Having saved the data packets in this manner, this allows the data packets to be associated with Solution Frameworks. The Solution Frameworks are questions defined within a hierarchical classification scheme that allow information relating the defined question to be retrieved. The questions are generally directed to frequently researched areas of the industry, and accordingly, the Solution Frameworks typically represent frequently asked questions that require the generation of a report.

The classification scheme includes:
Products
   The most general level at which related information can be categorised. Products are generally offered as hyperlinked headings selected at the beginning of a search, for example: Market Profiles, Infrastructure Profiles, Short Term Outlook Monitor.
Profile Classes
   Broad categories into which Products can be divided. These may be offered as hyperlinked headings once a Product has been selected and include, for example: Domestic, International, General.
Profiles
   The specific grouping for the information required, such as “Backpacker International.” A list of related profiles may be displayed once a Profile Class has been selected.
Solution Frameworks
   Options presented to consultants to lead them closer to the information they require, often phrased as questions, such as “What attracts backpackers to Australia?”. When a consultant clicks a profile name, the list of Solution Frameworks for the profile is displayed.

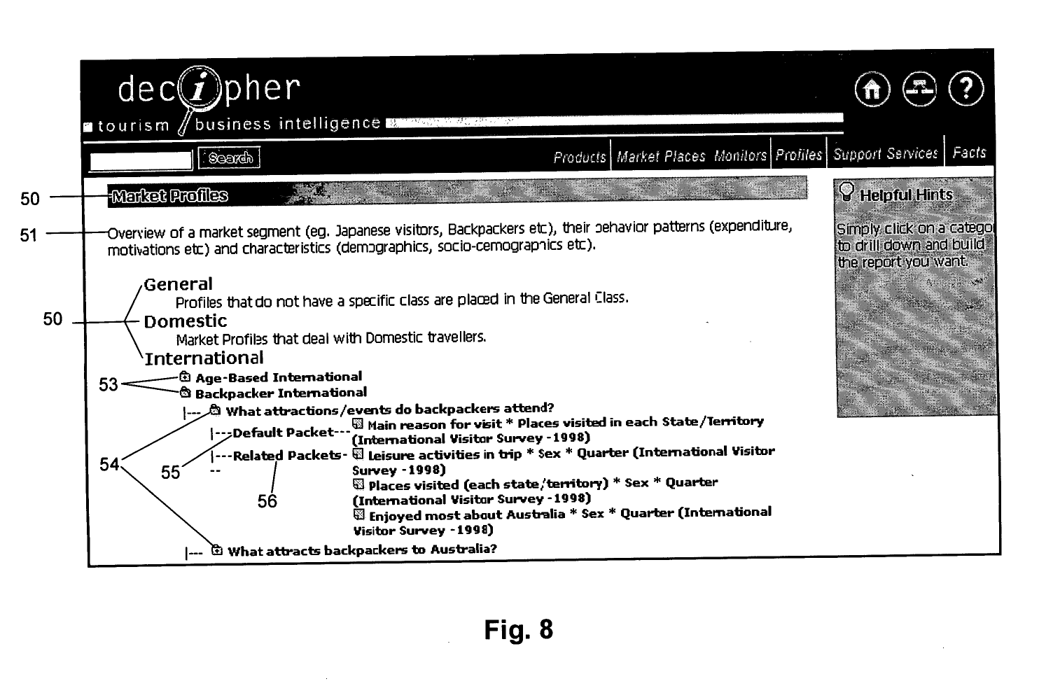

An example of the appearance of the hierarchical classification when presented to the users of the end stations 3, or an operative of the base station 1 is as shown in FIG. 8.

In this example, a market profile product is currently being displayed, as indicated at 50. A brief description of the market profile is provided at 51 with the profile classes contained therein being displayed at 52. As shown in this example, the market profile includes profile classes of “General”, “Domestic” and “International”. Within the profile classes are specific profiles, as shown at 53. In this example, the “Backpacker International” profile has been selected to show the solution frame “What attractions/events do backpackers attend?” at 54.

At 55 the default data packet(s) associated with this Solution Framework are shown, with related data packets being shown at 56.

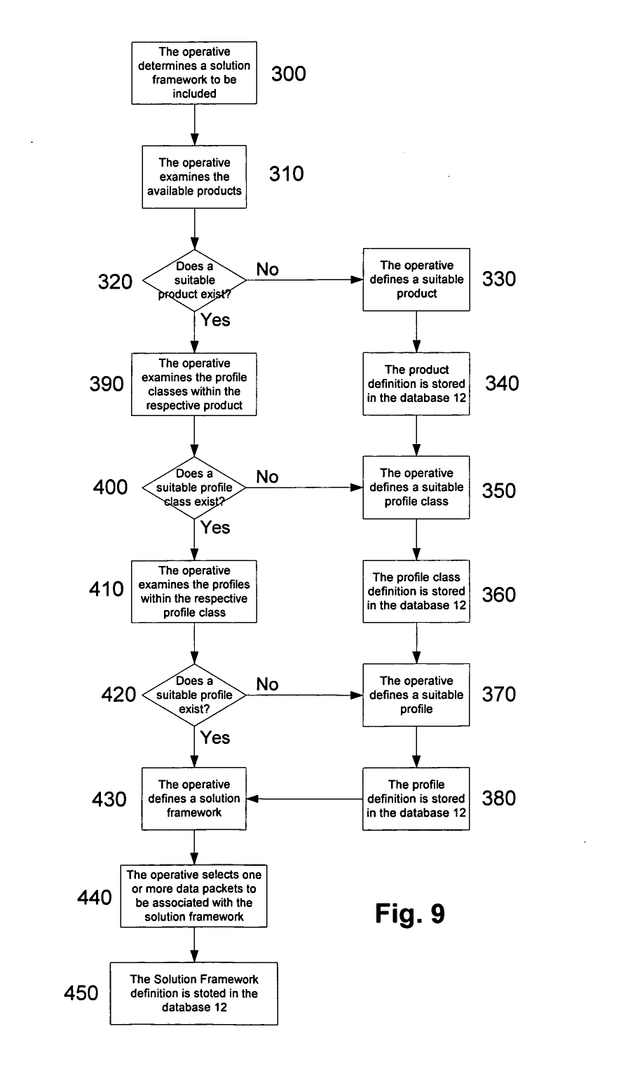

The manner in which the Solution Frameworks may be defined will now be described with reference to FIG. 9.

The Solution Frameworks may be defined by the users of the end stations 3, or by an operative by the end station 1. The following example is with respect to the operative of the base station 1, although the variations if a user of one of the end stations 3 define the Solution Framework is only minor.

Firstly, at step 300, the operative determines a Solution Framework to be included. Thus for example, the operative will determine the question “What attractions/events do backpackers attend?” as being a relevant question to the respective industry.

The operative then examines the products available on the system at 310. Details of the products, profile classes, profiles and Solution Frameworks are stored in the database 12 as respective product, profile class, profile and Solution Framework definitions. Accordingly, the base station I will obtain the definitions from the database and use these to present the user with a list of available products.

If the user determines that a suitable product does not exist, the user will proceed to step 330 to define a suitable product.

In order to achieve this, the operative is presented with a screen that allows the user to provide a product definition. The product definition will typically include a product and a brief description of the product as shown for example at 50 and 51 in FIG. 8. At step 340 the product definition is stored in the database 12.

The user is then asked to define a suitable profile class at step 350. Again, this is achieved by presenting the operative with a screen that allows the operative to define a profile class name and an associated description. This is stored as a profile class definition in the database 12 at step 360.

The operative then defines a suitable profile at step 370. Again this is achieved by the presentation of an appropriate screen allowing the user to define appropriate information. The profile definition is stored in the database 12.

In contrast to this, if the operative determines that a suitable profile exists at step 320 the method will proceed to step 390.

At step 390, the operative examines the profile classes available within the respective product. Again, this will be achieved by having the base station 1 determine the profile class definitions from the database 12, and then display these to the operative.

If a suitable profile class does not exist, then the method proceeds to step 350. Otherwise, the method proceeds to step 410 to allow the operative to examine the profiles within the respective profile class.

If a suitable profile is determined to exist at step 420 the method proceeds to step 430, otherwise a suitable profile is defined at step 370, as described above.

In any event, at step 430, the operative defines a Solution Framework in the form of an appropriate question. This will be achieved using an appropriate screen displayed by the base station 1 into which the user will enter the Solution Framework question. The operative also selects one or more data packets to be associated with the Solution Framework.

An indication of the respective data packets is provided on the screen and a definition of the resulting Solution Framework and an indication of the associated data packets is then stored as a Solution Framework definition in the database 12. This allows the data packets to be retrieved using the Solution Frameworks, as will be outlined in more detail below.

The process involved in having a user define the Solution Frameworks at one of the end stations 3 is substantially similar. In this case, however, the Solution Frameworks, and their respective definitions may be stored locally on the end station 3, or on a LAN 4, so that the defined Solution Frameworks are only available to local users. This may be performed, for example, if the Solution Frameworks are developed to address specific queries within a company, such as standard report generation or the like.

Alternatively, the defined Solution Frameworks may be stored centrally, either for access by limited individuals, or for access by general users of the system.

Data Retrieval

Once the data packets have been saved in the manner defined above, this allow users of the end stations 3 to subsequently search through the data packets and retrieve any content of interest. The manner in which this is achieved will now be described.

In this regard, FIG. 10 is an object-orientated representation of the structure of the data resulting from the manner in which the data is saved. As shown, users of the end stations 3 can access the data model shown generally at 40, via a search engine interface generated by the base station at 41.

The attributes of the data model 40 are coupled to respective keywords in the data dictionary represented at 42. The keywords in the data dictionary are then in turn coupled to the cubed data 43, the data packets 44 and the data elements 45.

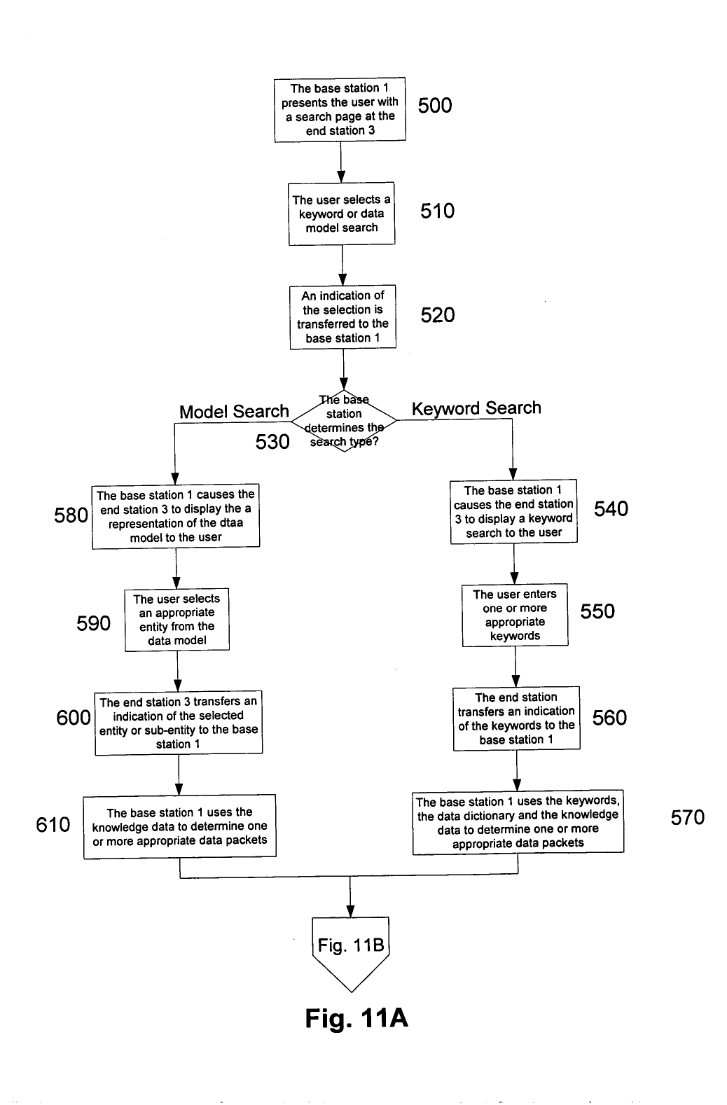

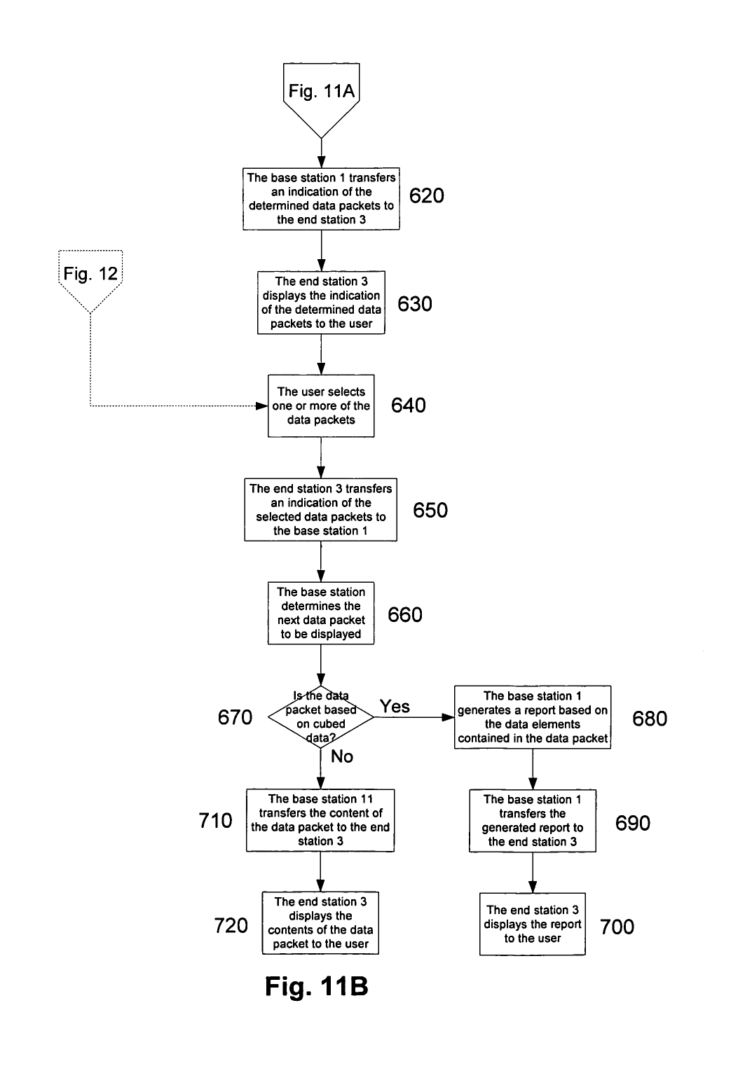

The manner, in which users can obtain data packets from the database 12, will now be described, with reference to FIGS. 11A and 11B.

Firstly, at step 500, the base station 1 presents the user with a search page at the end station 3.

In order to access the data, the user must typically be a registered user of the system. It will be therefore be appreciated that the user will typically be provided with a username and password during a registration process. The username and password, which will be stored as user data at the base station 1, typically in the database 12, is used by the base station 1 in validating the user, as will be appreciated by those skilled in the art.

The user data may also include additional information, for example to allow the base station 1 to record any costs associated with the data retrieval as will be described in more detail below.

In any event, in order to access the search page, the user will typically have to access a registration or log-in page presented by the base station 1. After providing the username and password, or registering to obtain a username and password, the user will be directed to the search page.

At step 510, the user selects a keyword or data model search. At 520 an indication of the selection is transferred to the base station 1. The base station 1 determines the search type at 530 and if the search is a keyword search proceeds to step 540 when the base station 1 causes the end station 3 to display a keyword search to the user. It will be realised that this may typically be achieved by presenting the user of the end station 3 with a web page including both data model and keyword search options, with the selection being made by providing appropriate information in a respective field.

The user will provide one or more appropriate keywords at step 550, which are then transferred from the end station 3 to the base station 1 of step 560. At step 570 the base station 1 uses the keywords, the data dictionary, and the knowledge data to determine one or more appropriate data packets.

Alternatively, if the user has selected the data model search, the process proceeds to step 580 where the base station 1 causes the end station 3 to display a representation of the data model to the user. The user then selects an appropriate entity or sub-entity from the model.

The manner in which this is achieved will depend on the manner in which the model is displayed. Thus, for example, the model may be provided as a flash object embedded in a web page. This would then allow the user to highlight the appropriate ones of the entities or sub-entities on the flash representation to thereby make a selection.

In any event, the end station 3 transfers an indication of the selected entity or sub-entity to the base station 1, thereby allowing the base station 1 to determine the data packets associated with the selected entity in accordance with the knowledge data at step 610.

The manner in which the data packets are identified based on the keyword or data model search will depend on the type of the respective data packets. In the case of non-cubed data, the base station 1 will identify the keyword or entity selection. The base station 1 then searches the data model for attributes similar to the user's selection, before mapping this attribute to an element in the data dictionary.

The base station 1 then uses this relationship and the knowledge data to identify relevant data packets.

In order to allow the base station 1 to identify whether a data packet based on cubed data is appropriate, the base station 1 operates to retrieve the elements (or columns) of the data packet from the database 12. These data packet elements are associated with elements in the data dictionary, which are in turn associated with attributes of the model. This allows a complete mapping of each individual element in a data packet to an attribute in the model, and therefore an entity or keyword. From this mapping, it is easy to determine to which entity or keyword a data packet is related.

Accordingly, the base station 1 uses the knowledge data to determine for each data packet the entities, sub-entities or keywords with which the data packet is associated, as described above. The base station 1 will therefore search the knowledge data of each data packet and determine those associated with the selected entity.

As shown in FIG. 11B, once the base station 1 has determined the data packets, the base station 1 transfers an indication of the determined data packets to the end station 3 at step 620. This will typically include the data packet name and description, thereby allowing the user to determine at least an indication of the data packet content. At step 630 the end station displays the indication of the determined data packets to the user, allowing the user to select one or more the data packets at step 640.

At step 650, the end station 3 transfers an indication of the selected data packets to the base station 1. Again, the manner in which this is achieved will vary depending on the implementation. Typically, however, the indication of each data packet could be displayed as a respective hyperlink which, when activated, will transfer the user to a web page that allows the content of the data packet to be presented.

In any event, at step 660, the base station determines the next data packet to be displayed. If the data packet is based on cubed data as determined at step 670, the base station 1 generates a report based on the data elements contained in the data packet at step 680, using a report builder, which is described in more detail below.

Once created, the base station transfers the generated report to the end station 3. At step 700 the end station 3 then displays the report to the user.

Alternatively, if the data is not cubed data, the base station 11 transfers the content of the data packet to the end station 3 at step 710, with the content being displayed to the user at step 720. Display of the data packet content may require the presence of appropriate application software on the user's end station. Thus, for example, if the data packet is formed from a PDF file, the user may require the Adobe Acrobat application software in order to view the content.

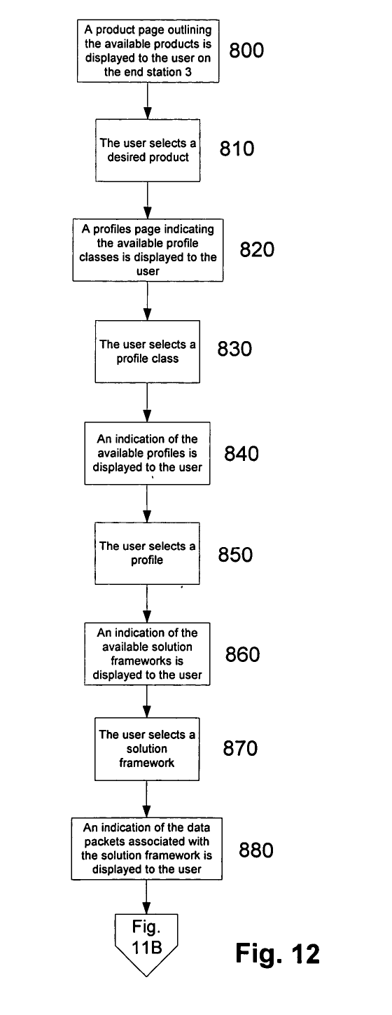

In addition to retrieving data packets in the manner described above, the user is also able to access data packets using Solution Frameworks as will now be described with reference to FIG. 12.

Firstly, as shown at step 800, a product page outlining the available products is displayed to the user on the end station 3. This will typically be in the form of a web page or the like. The user selects a desired product at step 810 which in turn causes a profiles page to be displayed to the user on the end station 3 at step 820, as shown for example in FIG. 8.

At step 830 the user selects one of the profile classes 52 and this causes an indication of the available profiles 53 are displayed at step 840. The user selects a desired profile at step 850, and this in turn causes an indication of the available solution of frameworks 54 to be displayed at 860. The user selects an appropriate Solution Framework at step 870 and an indication of the data packet associated with the Solution Framework is displayed at stage 880.

The data packet can then be selected from the displayed list of the one or more default data packets 55, or the related data packets 56. The manner in which the desired data packet can be selected is described in FIG. 11B at step 640 onwards.

The manner in which reports based on cubed data are generated will now be described.

Report Builder

The report builder is accessed by selecting a data packet, for example by using a model or keyword search or by the use of an appropriate Solution Framework as outlined above.

If the packet type is not cubed i.e. Word or PDF Document, the data packet is simply transferred to the user end station 3 for display. If it is a cubed packet, then user is presented with the first step of the builder.

The first step of the report builder allows the consumer the option to choose which elements from the data packet they wish to be displayed. For example, the packet may contain 4 elements, Regional Destination, Age, Country of Origin, and Sex. The consumer may feel that only the first three elements are relevant, so Sex can be de-selected.

The second step allows the consumer to restrict the data returned for each element selected in the previous step. The system selects all distinct values for each element and displays them as list to the consumer. The consumer has the option to select all the values, or choose from those in the list. As well as restricting the data that is returned the consumer also has the option to change the order of results. For example, the consumer may want Age to appear before Regional Destination, or vice versa.

The third and final step is viewing the data. The system queries the data dictionary, and data packet to return the data, which is displayed as per the consumer's preferences which have been stored in hidden form variables during the above described process.

The first piece of information is the Packet Name, Description, Cost, Supplier Name, Collection Name, Period, Frequency, and a Contact. This information is retrieved from the Data Dictionary based on the packet selected.

Below this, is the actual packet data itself in an iFrame (a page within a page in Internet Explorer). It is customised to the consumer's preferences. This data was retrieved by dynamically creating an SQL statement, running it, and displaying the results. Much work had to be completed to make this a fully dynamic feature. The elements and values for these elements are stored in form variables. The system then compiles a SQL statement, and sends this to the database. The database returns the data.

Some packets may have the option to be viewed in a Graph format. When this option is selected, the current results are formatted into a Pie Chart view. The option exists to alternate back to the table view.

Below the packet data is the Keys to Analysis, and the Related Packets. This information is also retrieved from the database. The related packets are calculated by searching each packet in the data dictionary for elements that exist in the current packet. For example, if Age is an element in the current packet, the system will search for all data packets that have Age as an element.

The consumer can then settle on the data, or select a Related Packet, and step through the report building process again.

Below is the code used to process the report building process. It allows for all steps in the process, and then passes to information obtained to a different ASP to display the results.

Accordingly, this system allows a variety of methods for information retrieval as well as a number of options for the way in which the information is presented. The users can search user the model, keywords or Solution Frameworks, and then refine the variety of data into a report, which specifically meets the users needs. For example a specific purpose business planning template can be used by an SME to produce a new, or update its existing, business plan and access the latest market data and information on competitive products in a form suitable for presentation to investors or lenders.

From the position of information supply the system has the ability to access data sources (such as ABS, BTR) at their origin. The system can access the data regardless of the format in which it is held. The information requested by users can be extracted from the available data and manipulated into business reports, graphs or personalised spreadsheets.

The system therefore allows storage of information in its native formats such as technical reports, research findings etc. Data is also accessed in a format that allows significant manipulation to derive a variety of information from the same data set, such as statistical tables. Both these types of information are stored in a central database, or can be accessed directly from the source as requested by the user.

Persons skilled in the art will appreciate that numerous variations and modifications will become apparent. All such variations and modifications which become apparent to persons skilled in the art, should be considered to fall within the spirit and scope that the invention broadly appearing before described.

1-23. (canceled)

24. A method of processing data, the data being of at least one of a first type in which the data is formed from a respective data instance and a second type in which the data is formed from a number of data elements, the method comprising the steps of:
receiving the data;
determining the data type; and
in the event the data is the first data type, defining at least one association between the data instance and at least one of a predetermined model, keywords, and other data instances;
in the event the data is the second type,
defining a data instance, the data instance being formed from at least one of the data elements;
defining at least one association between the data instance and at least one of a predetermined model, keywords, and other data instances;
storing the data instance in a store; and
storing knowledge data representing the defined associations in the store.

25. The method according to claim 25 wherein in the event the data is the second type, the step of defining the as least one association includes the steps of:
receiving at least one association with the data; and
applying the at least one association to each defined data instance.

26. The method according to claim 24 wherein the step of defining the at least one association includes the steps of:
determining content represented by the data;
determining the semantics of the content; and
performing at least one of comparing the semantics to the predetermined model to create an association therebetween and using the semantics to select at least one keyword; and
comparing the semantics to the semantics of other data instances to create an association therebetween.

27. The method according to claim 26 wherein the model includes at least one entity, each entity relating to a respective portion of the tourism industry, and the step of comparing the semantics to the predetermined model to create an association therebetween includes the steps of:
comparing the semantics of the content of each entity; and
creating an association between the entity and the data instance in response to a successful comparison.

28. The method according to claim 27 wherein the model includes at least one subentity, each subentity relating to a respective portion of the tourism industry, and the step of comparing the semantics to the predetermined model to create an association therebetween includes the steps of:
comparing the semantics of the content of each subentity; and
creating an association between the subentity and the data instance in response to a successful comparison.

29. The method according to claim 24 further comprising the step of receiving input from a user, via an associated processing system, wherein the processing system is adapted to perform the steps of:
receiving the data;
determining the data type;
display an indication of the content and the data type;
receiving input the user defining any associations;
generating the knowledge data; and
storing the knowledge data and the data instance in a store.

30. The method according to claim 29 wherein the store is a database.

31. The method according to claim 30 wherein in the event the data is the second data type, the step of storing the data includes the steps of:
generating a respective data table in the database; and
propagating the table with the content of the data instance, wherein each data element is placed in a respective column of the table.

32. The method according to claim 24 wherein the first type of data is a self contained document.

33. The method according to claim 24 wherein the second type of data is statistical data.

34. The method according to claim 33 further comprising the steps of:
determining the manner in which the data instance is to be displayed; and
including an indication of the manner in the knowledge data.

35. A system for processing data, the data being of at least one of a first type in which the data is formed from a respective data instance and a second type in which the data is formed from a number of data elements, the system comprising:
a store; and
a processor, wherein the processor is adapted to:
receive the data;
determine the data type; and
and
in the event the data is the first data type, define at least one association between the data instance and at least one of a predetermined model, keywords, and other data instances;
in the event the data is the second type,
define a data instance, the data instance being formed from at least one of the data elements;
define at least one association between the data instance and at least one of a predetermined model, keywords, and other data instances;
store the data instance in a store; and
store knowledge data representing the defined associations in the store.

36. The system according to claim 35 wherein the store is a database.

37. A method of retrieving data stored in a store, the data being stored as respective data instances, each data instance is associated with a predetermined model, the model including at least one entity, the method comprising the steps of:
selection at least one entity;
viewing an indication of each data instance associated with each selected entity;
selection one of the data instances; and
retrieving the data instance from the store.

38. The method according to claim 37 wherein the method is performed via a processing system coupled to the store, wherein the processing system is adapted to:
display the model to the user;
determine an entity selection in accordance with input received from the user;
determine each data instance associated with each selected entity;
display an indication of each data instance;
determine a data instance selection in accordance with input received from the user; and
retrieve the data instance from the store.

39. The method according to claim 38 further comprising the step of storing knowledge data representing at least one association and wherein in the step of determining each data instance associated with each selected entity, the processing system is further adapted to:
access knowledge data stored in the store; and
determine each data instance in accordance with the entity selection and the knowledge data.

40. The method according to claim 39 wherein the data of the first type is in the form of a self contained document, the data of the second type is in the form of at least one element, and in the step of retrieving the data from the store, the processing system is further adapted to:
determine the type of the data instance;
in the event the data is of the first type, display the content of the document to the user; and
in the event the data is of the second type,
obtain the data elements;
generate a report containing the data elements; and
display the report.

41. The method according to claim 38 wherein the processing system is comprised of first and second processing systems couple via a communication system, wherein the first processing system is adapted to:
receive input from the user and transfer an indication of the commands to the second processing system; and
display information received from the second processing system to the user, including at least one of the model, indications of the data instances, and data instances;
and wherein the second processing system is adapted to:
determine an entity selection in accordance with the user input received from the first processing system;
determine each data instance associated with each selected entity;
transfer the indication of each data instance to the first processing system;
determine the data instance selection in accordance with the user input received from the first processing system;
retrieve the data instance from the store; and
transfer the data instance to the first processing system for display.

42. The method according to claim 37 wherein each entity relating to the respective portion of the tourism industry, the data instances providing information relating to the tourist industry.

43. A system for retrieving data stored in a store, the data being stored as respective data instances, each data instance being associated with a predetermined model, the model including at least one entity, the system comprising:
a display; and
a processor adapted to:
display the model to the user;
determine an entity selection in accordance with input received from the user;
determine each data instance associated with each selected entity;
display an indication of each data instance;
determine a data instance selection in accordance with input received from the user; and
retrieve the data instance from the store.

44. The system according to claim 43 wherein the processing system is comprised of first and second processing systems couple via a communication system, wherein the first processing system is adapted to:
receive input from the user and transfer an indication of the commands to the second processing system; and
display information received from the second processing system to the user, including at least one of the model, indications of the data instances, and data instances.

45. The system according to claim 44 wherein the seconding processing system is adapted to:
determine an entity selection in accordance with the user input received from the first processing system;
determine each data instance associated with each selected entity;
transfer the indication of each data instance to the first processing system;
determine the data instance selection in accordance with the user input received from the first processing system;
retrieve the data instance from the store; and
transfer the data instance to the first processing system for display.

46. A model for use in data handling comprising:
at least one entity, each entity relating to a respective portion of the tourism industry;
at least one subentity, each subentity being associated with a respective entity; and at least one association, each association defining a relationship between a data instance and a respective one of the entities and subentities, the data instances representing content relating to the tourist industry.
